(19) United States
(12) Patent Application Publication
(10) Pub. No.: US 2010/0242192 A1
(43) Pub. Date: Sep. 30, 2010

(54) ENHANCED CLEANING AND TREATMENT DEVICE

(75) Inventors: Lennart Backman, Stockholm (SE); Magnus Carlsson, Vagnharad (SE)

Correspondence Address: YOUNG & THOMPSON, 209 Madison Street, Suite 500, Alexandria, VA, 22314, US

(73) Assignee: WALLENIUS WATER AKTIEBOLAG, STOCKHOLM (SE)

(21) Appl. No.: 12/744,138

(22) PCT Filed: Nov. 21, 2008
(86) PCT No.: PCT/SE08/51333

§ 371 Date: Jun. 2, 2010

(30) Foreign Application Priority Data
Nov. 23, 2007 (SE) 0702586-9

(51) Int. Cl. B08B 7/00

(52) U.S. Cl. 15/4

(57) ABSTRACT

A device for a liquid treatment unit includes a UV generating element, arranged inside a compartment, which compartment is arranged in a liquid treatment enclosure, which enclosure is arrange with an inlet and an outlet, wherein the compartment includes UV light permeable material, and wherein the liquid to be treated surrounds the compartment. The invention is characterised in that the device includes a mechanical cleaning element arranged to and capable of cleaning outer surface of the compartment when the unit is in operation.

### TECHNICAL FIELD

The present invention relates to a device to be used in a liquid treatment device utilizing UV generating means and in particular UV transmission allowing material between the UV generating means and the liquid to be treated.

### BACKGROUND OF THE INVENTION

There are many applications where UV generating means are used for treating liquids. The applicant for the present invention, Wallenius Water AB in Sweden, has developed and is selling water treatment equipment having a water purifier comprising an elongated tubular treatment chamber with an inlet and an outlet. In the centre of the treatment chamber a generally tubular quartz glass is arranged and inside the quartz glass a UV generating means, such as a lamp capable of generating wavelengths in the UV region. The inner surface of the treatment chamber may be covered with catalytic material, such as titanium dioxide, which catalysts promotes and increases the amount of treatment material.

Another type of treatment reactor developed by the applicant also comprises a treatment chamber having oppositely arranged in- and outlets, where the UV generating means are arranged in elongated quartz glass tubes. These tubes are arranged perpendicular to the flow of liquid to be treated through the treatment chamber. Further stacks of catalytic plates are arranged generally parallel to the flow and pierced by the UV generating means.

The above described treatment units are functioning very well for treating all sorts of liquids and in particular water, where the latter described treatment unit is specially adapted for treatment of ballast water in ships. The liquid that is treated often comprises particles and other solid matter other than the organisms that are killed off by the treatment units. These particles, as well as other residue from the killed off organisms, have a tendency to stick on the interior surfaces of treatment units, building up scaling. Regarding the catalytic surfaces, their function tends to be reduced when they become covered. The same applies to the quartz glasses surrounding the UV generating means, whereby the amount of radiation is decreased.

This means that in order to have an optimum efficiency of the treatment device the interior has to be cleaned regularly. According to one aspect cleaning is performed by injecting cleaning liquids into the treatment chamber, where the cleaning liquids are developed for removing the scaling on the surfaces. However, even if they are efficient for removing scaling and the like deposits on the surfaces of the treatment chambers, they require that the treatment units are closed down during a period of time, whereby thus no treatment of liquid may be performed.

### SHORT DESCRIPTION OF THE INVENTION

The aim of the invention is to provide an improved device for maintaining surfaces of a treatment unit in good operational condition as well as providing good exposure of catalytic surfaces inside the treatment unit.

This aim is achieved according to the present invention with a device according to the independent patent claims.

Preferable embodiments of the invention form subject of the dependent patent claims.

According to a main aspect of the invention, it is characterised by a device for a liquid treatment unit, which unit comprises UV generating means, arranged inside a compartment, which compartment is arranged in a liquid treatment enclosure, which enclosure is arranged with an inlet and an outlet, wherein the compartment comprises UV light permeable material, an wherein said liquid to be treated surrounds said compartment, characterised in that said device comprises mechanical cleaning means arranged to and capable of cleaning outer surface of said compartment when said unit is in operation.

According to another aspect of the invention, it is characterised in that said mechanical cleaning means is operated by the liquid flow through said treatment unit.

According to a further aspect of the invention, it is characterised in that said mechanical cleaning means is designed as a spiral wound around said compartment having its inner edge in contact with said compartment.

According to yet an aspect of the invention, it is characterised in that the mechanical cleaning means further comprises photo-catalytic material.

According to a further aspect of the invention, it is characterised in that said mechanical cleaning means is arranged as a liquid permeable material. Preferably the liquid permeable material comprises a quartz glass mesh.

According to yet an aspect of the invention, it is characterised in that the mechanical cleaning means is designed and arranged such that it is capable of cleaning the inner surface of the treatment enclosure.

These and other aspects of the invention will become apparent from the following detailed description and from the accompanying drawings.

There are a number of advantages with the present invention. The mechanical cleaning means ensures that at least the casing enclosing the UV generating means is worked on mechanically in order to maintain a good performance of the treatment unit, avoiding deposits and scaling to get stuck on the transparent walls surrounding the UV generating means.

Preferably the mechanical cleaning means is a spiral wound around the UV generating compartment, and wherein the flow of liquid causes the spiral to rotate around the compartment. The inner edge of the spiral will then be in contact with the transparent walls, thereby scraping off any deposits or scaling.

Further, the spiral may also be arranged such that it is in contact with the walls of the liquid containing enclosure, whereby the outer edge of the spiral is in contact with the inner walls of the liquid containing enclosure, thereby scraping off any deposits or scaling. This is particularly advantageous when the inner surface of the liquid containing enclosure is made of, or contains, a material that has photo-catalytic properties. Thereby there is a reduced risk that deposits or scaling is stuck on these surfaces, which otherwise would reduce the photo-catalytic effect.

According to a preferred embodiment, the mechanical cleaning means is made of, or comprises, material having photo-catalytic properties. This will further enhance the photo-catalytic reactions in the treatment unit, and in particular, when the mechanical cleaning means is a rotating spiral, because the surfaces of the rotating spiral will be exposed to the UV radiation throughout the treatment chamber.

Because the spirals provide an increased exposure of the photo-catalytic material to UV radiation, it is feasible to have such photo-catalytic spirals just for those properties and not primarily as cleaning means.

These and other aspects of, and advantages with, the present invention will become apparent from the following detailed description and from the accompanying drawings.

### BRIEF DESCRIPTION OF THE DRAWINGS

In the following detailed description of the invention, reference will be made to the accompanying drawings, of which

FIG. 1 is a side-view in cross-section of a first embodiment of the invention,

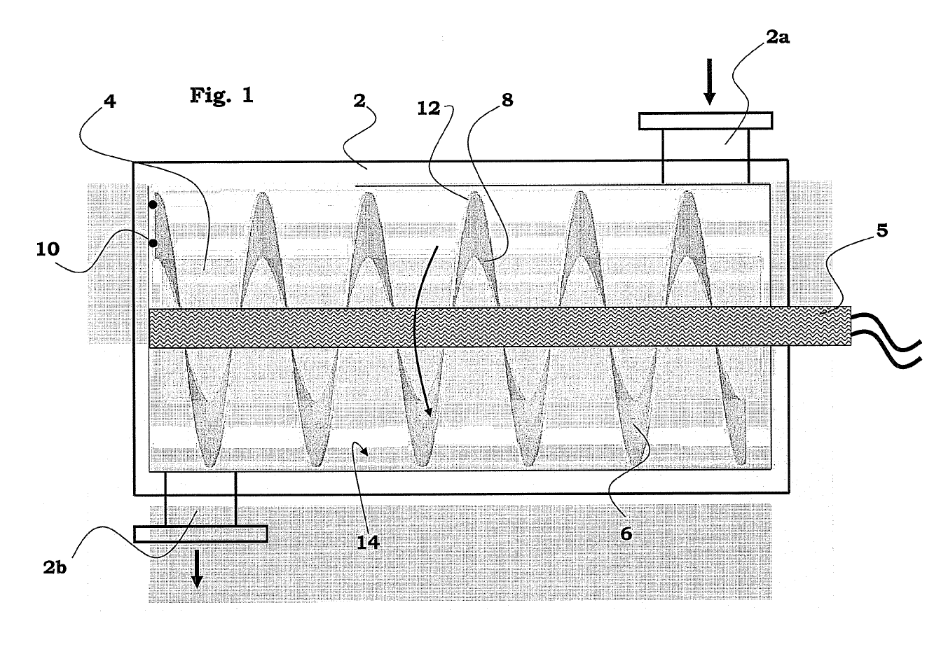

FIG. 2 is a side-view partly in cross-section of a second embodiment of the invention,

FIG. 3 is a side-view in cross-section of a third embodiment of the invention,

FIG. 4 is a side-view in cross-section of a fourth embodiment of the invention, and

FIG. 5 is a cross-sectional view taken along line V-V in FIG. 4.

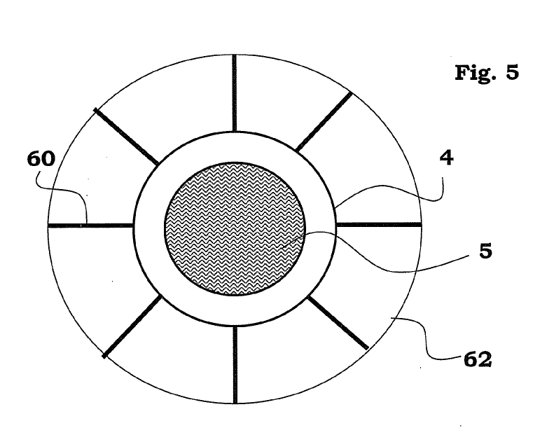

### DETAILED DESCRIPTION OF THE INVENTION

According to one embodiment of the present invention, it is arranged in a treatment chamber 2 of a generally tubular shape, having inlet 2a and outlet 2b connections for the liquid to be treated. In the centre of the chamber a generally tubular elongated tube 4 is arranged, which is made of a light transparent material such as glass, and in particular quartz glass. Inside the quartz glass tube a UV generating means 5 is arranged, such as a lamp capable of generating light in the UV spectra.

Surrounding the quartz glass tube is a cleaning structure 6, in the shown embodiment a spirally shaped structure. The spiral is shaped such and has such dimensions that the inner edge 8 surface of the spiral is in contact with the quart glass tube 2. Preferably the inner edge is made of a material having some resiliency and thus some wiping properties. Further, the spiral is arranged such that it is capable of rotating around the quartz glass tube. Preferably the spiral is journalled at the ends by suitable bearing means 10. The rotation is then obtained by the water flowing through the treatment chamber during treatment, in the embodiment shown the flow of liquid is generally parallel to the UV generating means and the quartz glass tubes. Thus when the spiral is rotated around the quartz glass tube, the inner edge slides over the outer surface of the glass tube, thereby scraping off any solid objects and other material that may have been stuck on the surface. Also, since the spiral rotates, and the surface of the glass tube is continuously wiped, less material is able of being stuck on the surface.

The bearing means 10 may for example be ball or roller bearings of a material suitable for the environment, but may also be sliding bearing of e.g. PTFE or other type of suitable material.

Also, or instead, the outer edge 12 of the spiral may be in contact with the inner surface 14 of the treatment chamber, which inner surface preferably is covered with catalytic material, such as titanium dioxide. In this context the whole treatment chamber may be made of titanium for corrosion purposes, and then the inner surface of the treatment chamber is treated in a suitable manner in order to create a titanium dioxide layer. Instead of catalytic material, the inner surface of the treatment chamber may be provided with reflecting material, which increase the spreading of the UV radiation, which surface also needs to be cleaned regularly.

As a further embodiment, the spiral may be made of a catalytic material, or covered with catalytic material or having catalytic material embedded in the spiral material. The catalytic material may comprise any material metals, alloys and the like capable of creating photo-catalytic reactions in the liquid to be treated together with the UV radiation. Further the spiral may made of a solid material, thereby providing a plate-like surface, but it is also feasible that the spiral is made of a porous material, like a mesh, for example of quartz glass. This has the advantage that the spiral as such does not affect the spreading of the light through the treatment chamber. By using the spiral as catalytic carrier, the catalytic surfaces in the treatment chamber are increased. Another advantage is that the structure affects the flow of liquid through the treatment chamber such that a mixing is obtained in the liquid, thereby increasing the efficiency of the treatment.

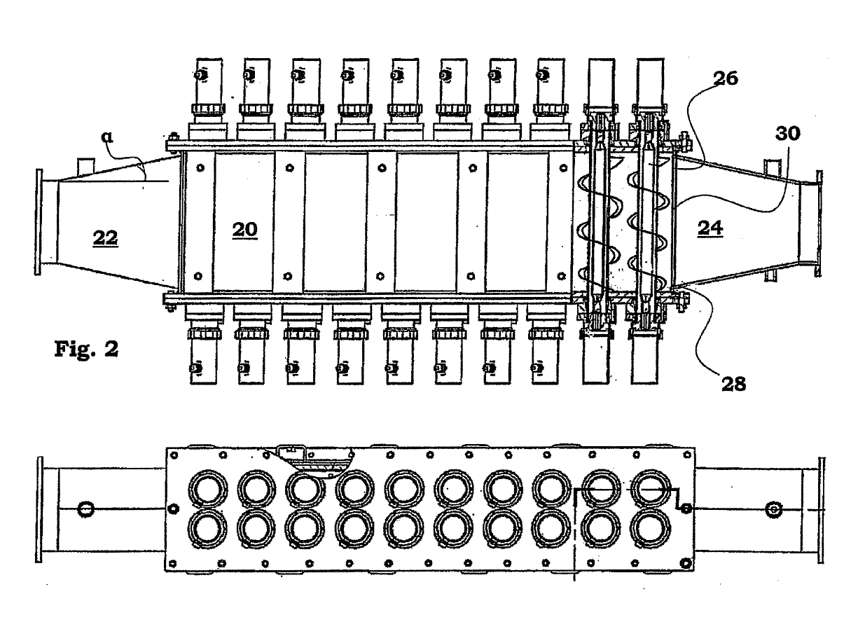

According to a further aspect of the invention it is of course possible to use the rotating spiral structure without the cleaning feature, i.e. the inner or outer edges do not come in contact with any surfaces. The rotating spiral structure is instead used to expose the catalytic material as effective as possible to the UV radiation. FIG. 2 shows an alternative embodiment of a treatment chamber 20, having inlet 22 and outlet 24, where the UV generating lights 26 are arranged in quartz glass tubes 28 that are placed perpendicular to the flow of liquid. Each glass tube is surrounded by at least one spirally wound photo-catalytic member 30, that are arranged rotationally around the glass tubes. Thus when liquid flows through the treatment chamber, the flow will cause the spirals to rotate, whereby the photo-catalytic surfaces are exposed to the UV radiation from the lamps.

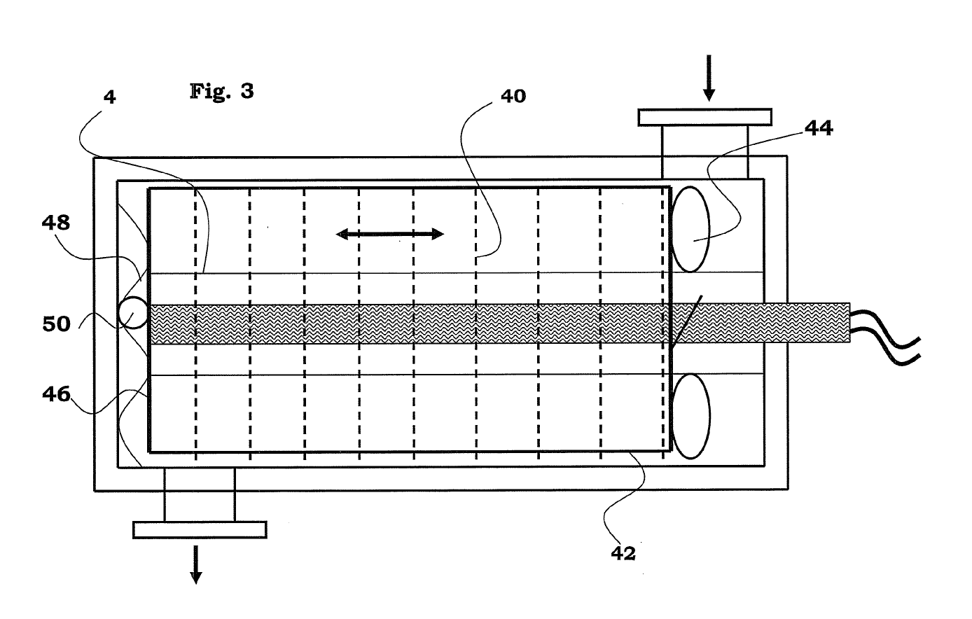

FIG. 3 shows an alternative embodiment of the present invention. Here, instead of a spiral, the cleaning structure comprises a number of concentric discs 40 surrounding the elongated tubular glass, where the inner surfaces of the discs are in contact with the surface of the tube 4. The discs are interconnected with suitable connection members 42 to form a stack of discs. Further a number of turbine blades 44 are attached to the stack of discs for enabling a rotation of the stack of discs when liquid is flowing through the treatment chamber. At the lower end of the stack of discs, to the left in the figure, a planar surface 46 is arranged and at the end surface of the treatment chamber a sinus-shaped surface 48 is arranged. A number of rollers 50 are arranged between the planar surface and the sinus-shaped surface such that when the stack of discs is rotated the sinus-shaped surface will cause the stack to move forth and back along the tube, whereby the inner edges of the discs, in contact with the tube, will scrape off any scaling or deposits on the glass tube. With this embodiment, the discs are preferably of a porous material or with a mesh-like structure in order that the liquid flow is not obstructed too much.

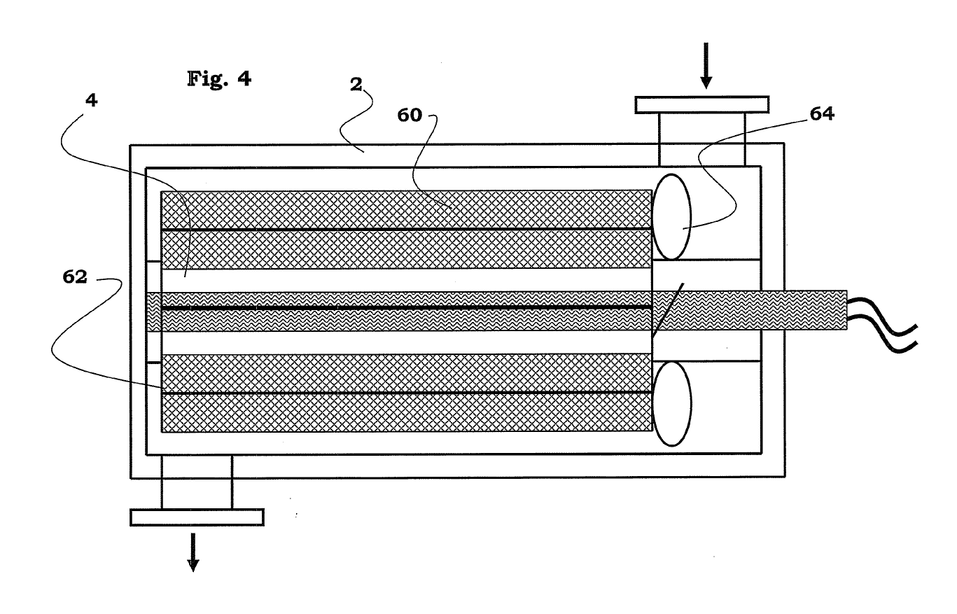

FIG. 4 and show a further embodiment wherein the cleaning structure comprises a number of plate-like members 60 arranged generally parallel with the longitudinal direction of the glass tube 4, where the inner surfaces of the plate-like members are in contact with the surface of the tube. The plate-like members are inter-connected with suitable connection members 62 to a package and arranged to a turbine 64, capable of rotating the package. Further, suitable means are arranged for enabling easy rotation of the package (not shown). Thus, when liquid is flowing through the treatment chamber, the flow causes the package to rotate and to clean the surface of the glass tube.

It is to be understood that the embodiments described above and shown in the drawings are to be regarded as only non-limiting examples of the present invention and that it may be modified in many ways within the scope of the patent claims.

1. Device for a liquid treatment unit, which unit comprises UV generating means, arranged inside a compartment, which compartment is arranged in a liquid treatment enclosure, which enclosure is arrange with an inlet and an outlet, wherein the compartment comprises UV light permeable material, and wherein said liquid to be treated surrounds said compartment, characterised in that said device comprises mechanical cleaning means arranged to and capable of cleaning outer surface of said compartment when said unit is in operation.

2. Device according to claim 1, characterised in that said mechanical cleaning means is operated by the liquid flow through said treatment unit.

3. Device according to claim 2, characterised in that said mechanical cleaning means is designed as a spiral wound around said compartment having its inner edge in contact with said compartment.

4. Device according to claim 1, characterised in that the mechanical cleaning means further comprises photo-catalytic material.

5. Device according to claim 4, characterised in that said mechanical cleaning means is arranged as a liquid permeable material.

6. Device according to claim 5, characterised in that the liquid permeable material comprises a quartz glass mesh.

7. Device according to claim 3, characterised in that the mechanical cleaning means is designed and arranged such that it is capable of cleaning the inner surface of the treatment enclosure.

8. Device according to claim 7, characterised in that said spiral is arranged with its outer edge in contact with the inner surface of the treatment enclosure.

9. Device according to claim 2, characterised in that the mechanical cleaning means further comprises photo-catalytic material.

10. Device according to claim 3, characterised in that the mechanical cleaning means further comprises photo-catalytic material.

11. Device according to claim 1, characterised in that the mechanical cleaning means is designed and arranged such that it is capable of cleaning the inner surface of the treatment enclosure.

12. Device according to claim 2, characterised in that the mechanical cleaning means is designed and arranged such that it is capable of cleaning the inner surface of the treatment enclosure.

13. Device according to claim 4, characterised in that the mechanical cleaning means is designed and arranged such that it is capable of cleaning the inner surface of the treatment enclosure.

14. Device according to claim 5, characterised in that the mechanical cleaning means is designed and arranged such that it is capable of cleaning the inner surface of the treatment enclosure.

15. Device according to claim 6, characterised in that the mechanical cleaning means is designed and arranged such that it is capable of cleaning the inner surface of the treatment enclosure.
